(19) United States
(12) Patent Application Publication
(10) Pub. No.: US 2009/0012856 A1
(43) Pub. Date: Jan. 8, 2009

(54) Method of marketing local products and/or services

(75) Inventor: William Sweeney, Weare, NH (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: Danconia Media

(21) Appl. No.: 11/825,216

(22) Filed: Jul. 3, 2007

(51) Int. Cl. G06Q 30/00

(52) U.S. Cl. 705/14

(57) ABSTRACT

A method of marketing local products and/or services includes establishing a database of providers of local products and/or services, wherein the providers are classified into one or more business categories and each provider is certified prior to inclusion. User requests are received for information about providers of local products and/or services in a specified business category, and a list of providers classified in the specified business category is displayed to the user in response to the request. The list has a limited number of providers to avoid an excessive number of choices.

### BACKGROUND OF THE INVENTION

This invention relates generally to methods for promoting and marketing products and/or services and more particularly to “local” products and/or services.

As the amount of information pertaining to products and services increases worldwide, their relevance as it pertains to any geographical or genealogical locale is diminished (“genealogical” meaning related to a particular subset or group of participants). Information interference, as well as information overload has presented a very large problem for local providers of products and/or services. The ability to obtain relevant information has become exceedingly more difficult, if obtainable at all. As this information has become more “available”, sources that disseminate the information as to its relevance have become paralyzed by the very existence of the growing amount of data. Traditional outlets for the display of information regarding products and services suffer from advertising interference, and online sources of information pertaining to “local” products and services have failed to properly disseminate what is “local” and what is not. The remaining portion of providers of this “local” information choose to provide national and global results as part of their “local” offering, driving consumers away from local sponsors and into the offerings of high paying national and global corporations and resellers. Social networking methods currently employed are riddled with flaws and shed serious doubts over the validity of the results.

Current methods, such as directories and search engines, for obtaining information online regarding local communities and their larger metro areas with regards to products and services are generally fragmented and incomplete. There is no condensed source that includes all of the needed information to make an educated, safe, and reliable choice with regards to providers of products and/or services, nor is there any single source to obtain information pertaining to local businesses and the products they offer. These current methods merely display results as they are cultivated, or paid for in the form of advertising premiums, without any true provisioning for the level of quality that is presented by the displaying vendors. Online directories list links to businesses for a small fee. These sites have limited promotion, are designed by web developers, have no sales and marketing expertise and design specifications, and are too broad in scope to be effective in a small local area. They are national in presence, or offer national exposure on what they deem are “local” presences. Such directories offer no direct way of differentiating companies offerings with regards to value, and service. Directories dilute the effectiveness of their listings by providing too many alternatives, too many unknowns, and unreliable data. Their primary listing criteria is alphabetical, severely penalizing those entities that are “alphabetically challenged.” No sales and marketing presence exists and web design is poorly done. Sites are not intuitive and difficult to traverse; links often direct users to national directories that just re-display Yellow Page listings.

Search engines geared for local searches, such as Google Local, are generally based upon a nationally and internationally scaled search engine that spiders the World Wide Web for local content. This form of local search is overly broad and ambiguous which is not conducive to an efficient or effective local search mechanism for consumers. Results are varied and untargeted and tend to feature large companies or companies that are not located in the geographic region searched by the consumer. Search engines frequently display thousands of results. This makes the search process even more difficult for searchers and increases the time they spend browsing results. This large amount of information is not organized resulting in an information overload situation for consumers. This will reduce consumers' likeliness to buy goods or services and may push them away from the search engine. Search engine services typically employ a Pay Per Click (PPC) fee model. However, this system has come under attack because of the large number of fraudulent clicks that links receive. Results issued by Outsell Inc. show that 14.6% of all clicks are fraudulent and that advertisers lost an estimated $800 Million to click fraud in 2005. Paid search results contain 2 to 4 times as many dangerous sites (sites that attack consumer computers using viruses or other exploits) when popular keywords are searched. Search Engines index billions of pages of content, much of it dangerous to children. This happens because web pages are indexed by bots, not human eyes, and are built to contain as much information as possible.

Other well known methods for local providers to attract customers include listings in phonebooks and newspapers. However, these approaches are not targeted, lack cross marketing opportunities, are expensive with respect to return, and are susceptible to advertising interference. Direct mail in another option, but this is extremely expensive and untargeted.

Accordingly, there is a need to determine what “local” sources are credible in nature. There is need for a truly trusted local source of information regarding the local products and/or services available that deal with the inefficiencies of the current methods.

### SUMMARY OF THE INVENTION

The above-mentioned need is met by the present invention, one embodiment of which includes a method of using a computer-based system to market local products and/or services. The method comprises establishing a database of providers of local products and/or services, wherein the providers are classified into one or more business categories and each provider is certified prior to full inclusion. User requests are received for information about providers of local products and/or services in a specified business category, and a list of providers classified in the specified business category is displayed to the user in response to the request. The list has a limited number of providers to avoid an excessive number of choices.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a block diagram of a computer-based system capable of implementing an engineered portal system.

FIG. 2 graphically illustrates an exemplary user interface screen.

FIG. 3 graphically illustrates an exemplary provider by category page.

### DETAILED DESCRIPTION OF THE INVENTION

Representative embodiments of the present invention include, among other things, methods for promoting and marketing products and/or services, particularly “local products and/or services”. As used herein, the term “local products and/or services” refers to products and/or services that are primarily available to or directed to a specific community, i.e., a particular physical or geographic location or a group of people with one or more common characteristics or interests. Thus, the term “local” refers to: 1) a particular physical locale, such as a town or city, or 2) a group of people sharing a common denominator such as “art”, “equestrians”, etc.

The methods of the present invention allow providers of local products and/or services to maximize their revenues by utilizing a comprehensive “engineered portal system” that accommodates social, psychological, economic, and general behavioral principles overlooked by existing search solutions. One aspect of the engineered portal system is an integrated sales and marketing engine (ISAME) that maximizes these principles to drive targeted consumers to the providers of products and/or services they have a “local” connection to. The ISAME is designed around many scientific principles of consumer behavior, including but not limited to, behavioral buying patterns, choice factors, behavioral risk aversion factors, online viewing patterns, online consumer hardware specifications, demographic population statistics, advertising interference statistics, graphical aesthetic preferences, complete information theories, social welfare factors, geographical limitation factors, geographic economies of scale, factors of consumer reaction to information overload, as well as an innovative new method of driving local viewership to a specified online\digital or physical location.

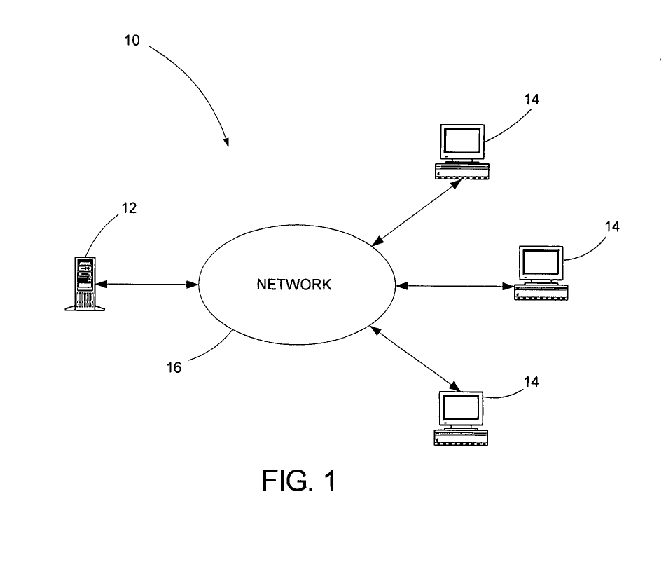

Referring now to the drawings wherein identical reference numerals denote the same elements throughout the various views, FIG. 1 shows one embodiment of a computer-based system 10 capable of implementing the engineered portal system. The computer-based system 10 includes a central host or server computer 12 and one or more client devices 14 (only three shown in FIG. 1, but more or fewer could be used) connected by a computer network 16. The network 16 is preferably the World Wide Web, although it possible to employ other types of computer networks such as a local area network or a wide area network.

As used herein, the “World Wide Web” (or simply the “Web”) refers to the collection of servers and other devices on the Internet that support exchange of interlinked, computer viewable hypertext documents (commonly referred to as web pages). As is known in the art, such hypertext documents are accessed with client and server software using standard Internet protocols such as Hypertext Transport Protocol (HTTP) and Transmission Control Protocol/Internet Protocol (TCP/IP). Web pages are formatted in mark-up languages that support electronic links of hyperlinks to other documents as well as to graphics, audio, video, animation and other types of content. The mark-up languages include Hypertext Markup Language (HTML), Extensible Markup Language (XML), and many others. However, as used herein, the terms “World Wide Web” and “Web” are intended to encompass not only HTTP, TCP/IP, HTML, and XML, but also any current or future transport protocols or markup languages that may be used.

The client devices 14 may be any type of computing devices that are capable of transmitting requests and receiving web pages over the network 16. For example, the client devices 14 can include, but are not limited to, personal computers, work station computers, laptop computers, wireless devices, mobile phones, personal information devices, personal digital assistants, hand-held devices, network appliances, pagers, etc.

The server computer 12, which can be a single computer device or a plurality of connected computers, has the above-mentioned engineered portal system (including a database of approved, certified providers) stored thereon and includes a web server (i.e., logic processing software that serves requested web pages or files). Each client device 14 includes web browser software that allows users to access the server computer 12, as well as other data stored on any other server systems connected to the network 16. Generally, the web server receives requests to access web pages from one or more of the client devices 14 and provides the web pages to the requesting client devices 14.

To utilize the system 10, a user accesses the engineered portal system on the server computer 12 with one of the client devices 14. Specifically, the user is able to access and launch the engineered portal system by sending a request to the server computer 12 by inputting the appropriate Internet address or selecting the appropriate link on a web page. The server computer 12 responds by downloading a user interface screen or index page for a local engineered portal system and thereby causing the user interface screen to be displayed on the requesting client device 14.

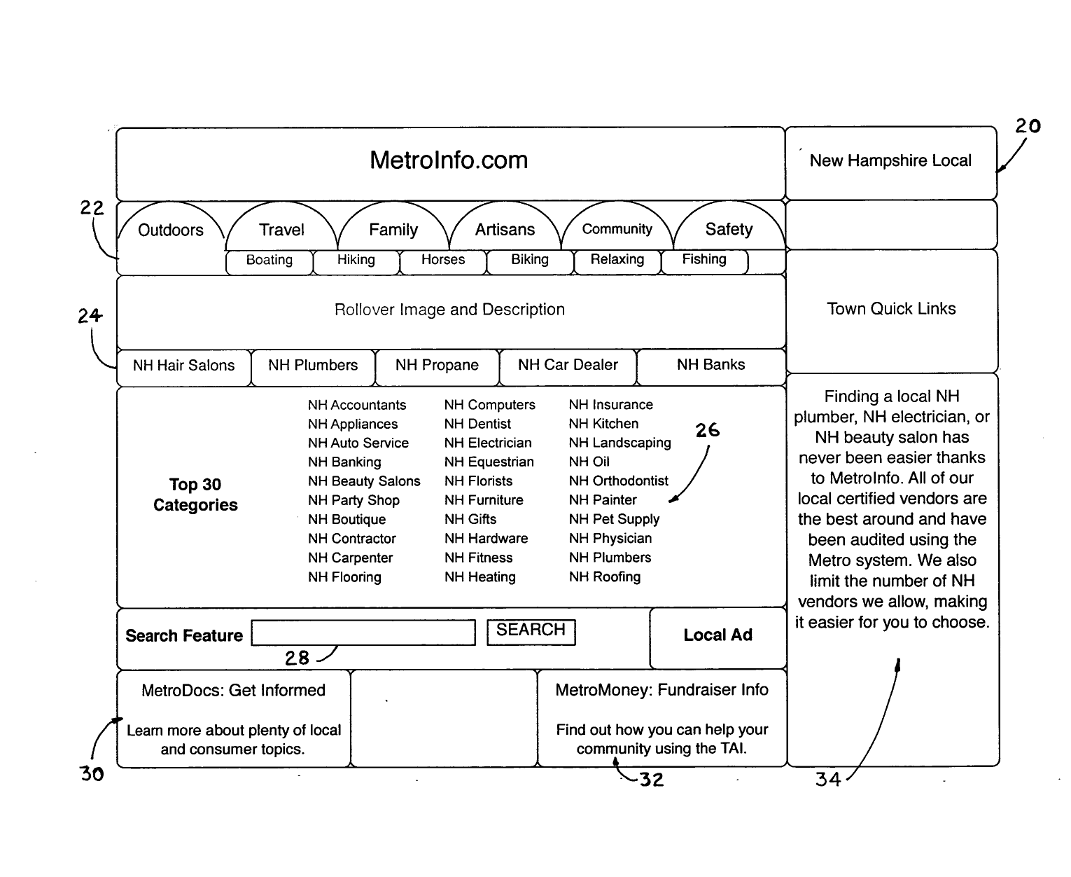

Referring to FIG. 2, an exemplary user interface screen 20 for the engineered portal system is depicted. The user interface screen 20 allows users of the ISAME to coordinate projects and assimilate information relevant to those projects within the ISAME. This interface may be a drag and drop interface, or may be an option based interface, or a combination of both. Users will be able to manage one or many projects within the user interface. Tasks such as organization of ideas, offers to bid, receipt of quotes, and feedback on results also will be available. In the illustrated embodiment, the user interface screen 20 includes a custom local tab bar 22, a localized main menu rollover 24, a localized quick link directory 26, a localized ISAME search bar 28 with featured local business, a consumer safety and information provisioning section 30, a Targeted Audience Initiator (TAI) tie in 32, and a localized content optimization segment for online ranking 34.

The local tab bar 22 is a locale-specific quick link location for products and services of distinction, or of specific interest to a particular locale. The local tab bar 22 will vary depending on the locale serviced within the ISAME. This personalizes the ISAME to the given locale. The local tab bar 22 includes a number of tabs that users can select or click on to display products and services of a particular category. In the illustrated embodiment, the local tab bar 22 includes tabs for outdoors, travel & leisure, artisans, etc., as these are key aspects of the local culture covered by the ISAME. Other locales, such as horse country in the area of Ocala Fla. or areas throughout Kentucky, might include a section on equestrians, as another example of how the local tab bar 22 could be customized.

The localized main menu rollover 24 is used to highlight a number of local solutions for consumers. In a space typically utilized for one message the rollover area is optimized for the presentation of several local offerings, while allotting a large area for display for each offering. These rollovers are local in nature and represent offerings for providers per category represented in the ISAME. Again, specific to a local environment as all other elements are. Rolling over each segment presents a message and a link to the category page with provider displays per category. Clicking on the local message link brings up a provider page where users can view products and services and communicate with providers of products and services represented.

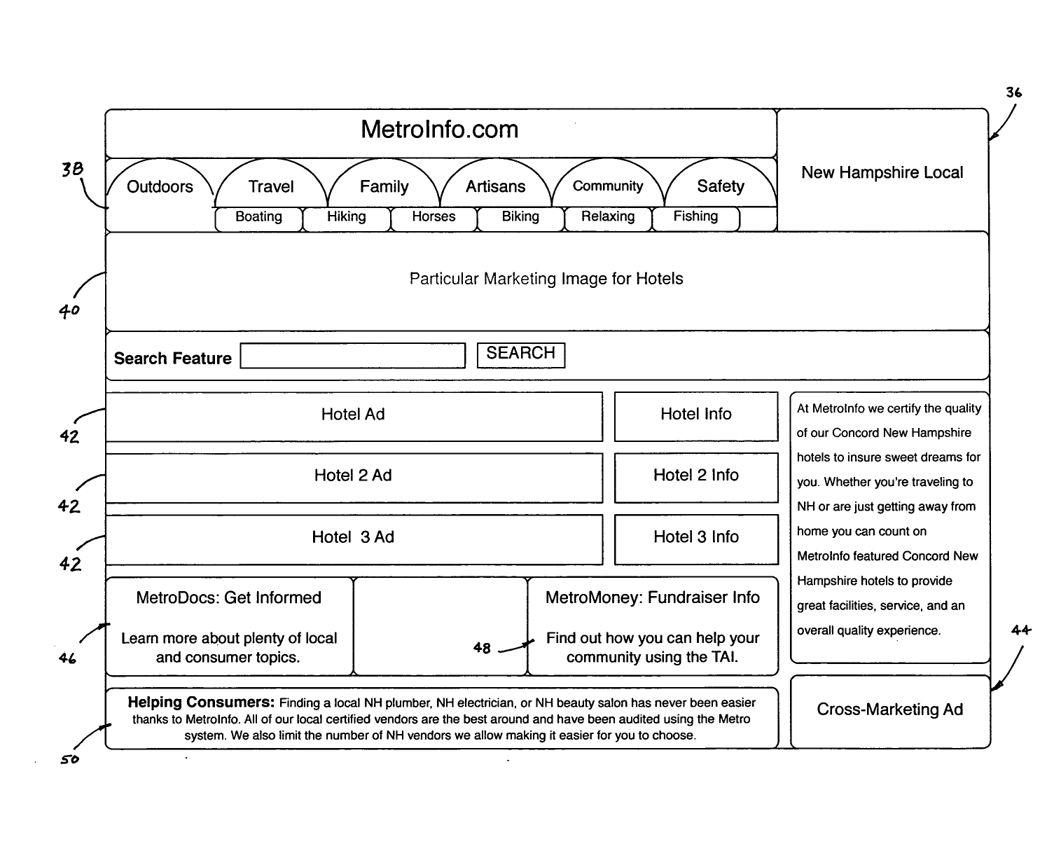

When a user selects or clicks on the localized quick link directory 26, the server computer 12 causes a directory page listing approved, certified providers of local products and/or services by business category (e.g., plumber, carpenter, accountant, real estate agent, etc.) to be displayed on the user's client device 14. The user is then able to click on the category of interest to view the select local providers listed for that category. The ISAME search bar 28 presents another mode for allowing users to find approved, certified providers of local products and/or services. For example, if a user wants to find local plumbers, he or she would enter “plumber” in the search bar 28 and click on the “Search” button adjacent to the search bar 28. Then, a list of approved, certified plumbers from the database would be displayed on the user's client device 14. FIG. 3 depicts an example of how this information might be displayed in the form of a provider by category page 36. The provider by category page 36 includes a custom local tab bar 38, an optimized title image bar 40, provider sections 42 including graphic and text portions in which the select providers for the particular business category are listed, a cross marketing section 44 that provides a space for listing a screened and accepted complimentary offer, a category-specific consumer safety and information provisioning section 46, a Targeted Audience Initiator (TAI) tie in 48, and a localized content optimization segment for online ranking 50. As will be described in more detail below, there will be a limited number of provider sections 42 included on the provider by category page 36. The illustrated example shows three provider sections 42 for listing three approved providers, but the present invention is not necessarily limited to this number.

Referring again to FIG. 2, the user will be able to access consumer safety information by clicking on the consumer safety and information provisioning section 30. This will present informational articles on many topics including consumer protection, family articles, travel guides, news articles, and other content that will draw people to the portal. Moreover, this information will facilitate a positive purchasing outcome because consumers are more likely to make a decision without further research when they have full inclusion of information pertaining to a topic. Providing consumer safety information will thus tend to generate an increase in sales.

The Targeted Audience Initiator (TAI) tie in 32 is implemented to provide a mechanism to 1) create a coordinated socio economic platform that is circular in nature, and 2) be a driver of traffic to the ISAME for the mutual benefit of the ISAME participants, the consumer, and consumer groups in the form of charitable organizations, schools, and others. Use of a Targeted Audience Initiator (TAI) arrangement is described in more detail below.

The localized content optimization segment for online ranking 34 provides pertinent information regarding a topic with a specific focus on the particular area the ISAME services. Unlike generic content such as automobile buying, this section would include specific information regarding buying a car in a specific locale. This deliberate creation of pinpoint local market content increases the likeliness of high ranking for the specific area within the major online search engines. This in combination with locale providers in the local tab bar 22, as well as the other optimized sections within the interface, also increase ranking by utilizing associated links and content.

The basic functioning of the present invention will now be described. An organization (referred to herein as an “operating organization”) decides to initiate an engineered portal system utilizing ISAME technology to present information regarding local products and/or services. This operating organization may provide funding and personnel to support the rollout and growth of the portal and the ISAME. To initiate an ISAME portal, the operating organization begins a business process that includes, among other things, researching a local area to determine its market structure, deciding upon the optimum number of businesses per category, and determining a pricing structure.

The operating organization also decides which business categories (e.g., plumber, contractor, real estate agent, etc.) are to be included in the portal. Each business category has a limited, optimized number of openings or spots for providers. This optimization allows the ISAME to create a coordinated economy, save consumers time when making choices, and give featured businesses market exclusivity.

The operating organization then recruits providers of local products and/or services for the various categories that are to be included in the ISAME. Using a localized sales force, the organization approaches local businesses and sells entry into and a continuing inclusion in the ISAME portal to approved providers of local products and/or services. To be featured in the ISAME portal a local provider must pass a certification and auditing test. For example, the certification process can include having local providers that would like to be included in the ISAME portal fill out an identification form for their business and submit it to the operating organization. Using this form, the operating organization will conduct comprehensive background searches on the applicants, including financial stability and criminal checks. These steps will insure protection of consumers from business bankruptcies and criminal activities. Providers wishing to be in the portal will provide customer references pertaining to the quality of their work. Generally, the references will be interviewed in person or via telephone to insure authenticity, and the basic information obtained from the references will be verified using independent sources. The references will also be given the opportunity to submit a written report of the businesses activities that they experienced, if they choose to. In addition, the operating organization will interview owners and employees of the provider wishing to be entered into the portal. Staff members of the operating organization will be conducting the surveys to ensure that full and complete information is gathered. The surveys will be different depending on business segments. Generally, background information and reference checks will be more thorough in cases where businesses will be in contact with clients in their homes. Businesses that operate in more public places, such as coffee shops, will have much less stringent checks. By following these steps, the operating organization can insure that consumers using the portal will be safe from unethical businesses and their employees. Consumers will have confidence in the portal because of the consumer protection searches and background checks that are conducted, and consumers will be able to trust the portal and it's featured businesses. Consumers will continue to use the portal because of its reliability. Furthermore, the featured providers will have more credibility because of the enhanced credibility of the portal. Increased credibility will allow featured providers to charge more for their services, because consumers will pay more to do business with a reputable company.

Any provider wishing to be featured on the portal must agree to adhere to a code of conduct setting forth certain entrance requirements to be included in the portal. For example, the entrance requirements for any business that provides contracting services, including but not limited to, construction, renovation, electrical installation & repair, plumbing installation & repair, and carpentry could be as follows:
The provider will adhere to specified code of business ethics.
At least for providers that do not have a verifiable background check policy for their employees, the operating organization will conduct thorough criminal and bankruptcy background checks on all employees that may come in contact with consumers.
The provider will allow the operating organization to conduct an in depth business audit on their company which will draw from all available resources.
The provider will allow the operating organization to conduct random spot audits to ensure that a business is adhering to the code of business ethics.
The provider must have all necessary licenses to operate in the locality that the portal represents. The operating organization will insure this with thorough checks.
The provider will have Public Liability Insurance.
The provider will have Property Damage Insurance.
The provider will provide workers' compensation for all their employees as well as their subcontractor's employees.
The provider provides sufficient warranty on parts and labor depending on profession.
The provider provides a quality-finished product that is acceptable to all applicable building codes.
The provider will have sufficient business/financial stability to insure operation into the future.

A local provider will also be required to pay a set fee to the operating organization to be featured in the ISAME portal. Funds collected from the providers are used to pay for broad based marketing of the portal, portal maintenance, and to fund the operating organization.

Local consumers are brought to the ISAME portal through a number of ways. Marketing techniques may include a Targeted Audience Initiator (described below), search engine optimization (SEO), print, digital, radio, and television. After reaching the ISAME portal, consumers can find providers of local products and/or services by using the localized quick link directory 26, the ISAME search bar 28, or web page tab navigation.

When visiting the ISAME portal, consumers will find informational articles on many topics including consumer protection, family articles, travel guides, news articles, and other content that will draw people to the portal and also help retain consumer presences. This information is written and placed specifically and intentionally to present information that is relevant to the subject of the portal page. Furthermore, when consumers are visiting ISAME portal pages, the operating organization may decide to track consumer activities. Information such as consumer location, page hits, time spent on a page, and real time activities can be tracked.

The ISAME is not a conventional directory or a generic search engine; it is a sales and marketing engine designed to drive pinpointed, targeted traffic and revenue to its approved and certified providers of local products and/or services. The ISAME is a direct replacement for local directories and global search engine technology with respect to local searching. The ISAME limits participating providers (i.e., its clients) in each business category to a set number, with exceptions for outstanding service and products based on scientific research. This will enhance its client's prospects and increase its profitability by making the exposure of its clients increasingly more valuable. By doing so the ISAME creates a “coordinated local economy.” The ISAME provides functionality to assimilate local providers that are certified and trustworthy, enhancing buyer satisfaction and limiting buyer's remorse. This further contributes to creation of a coordinated economy. According to the ISAME's engineered formula for process, the revenues for the promoted providers will be significantly increased, as users of the ISAME will be more likely to take a positive course of action, in the form of a purchase, or provider specification.

One aspect of the ISAME is the provision for optimal levels of choice. Optimizing the number of choices for a given action can substantially increase the percentage of positive desired outcomes. The ISAME calculates an ideal number of choices, and displays those options to the using consumers. In one embodiment, the ISAME presents or displays of information representing providers of local products and/or services optimized for choice factors, weighted as well for factors of online viewing. Under normal purchasing mechanisms the provision of choice is a welcomed and needed factor. However, excessive choice can be overwhelming and can become debilitating in the process of purveying local products and/or services. Having too many choices can lead to consumer dissatisfaction. It has been shown in studies (See e.g., Botti, Simona and lyengar, Sheena, “The Dark Side of Choice: When Choice Impairs Social Welfare,” Journal of Public Policy and Marketing, (2006)) that consumers choose not to choose when they are presented with more choices, based on a more rather than less model. To overcome this problem, the ISAME creates a rational choice model that is optimized for choice factors, and weighted for current restrictions of online viewing statistics, thus implementing the optimal search environment for the purveyors of local products and/or services.

The ISAME utilizes a theory of limited choice weighted for viewing statistics such as online consumers desire to scroll, how far they will scroll, screen size dimension, pixel resolution, screen lines, and browser tool bar implementation to regulate how many choices are displayed for any piece of data, information, and graphical representation. The calculation should accommodate and take into consideration these other factors as there are negative feelings towards them, and they can outweigh the positive benefits of the optimal numbers of choice. As the ISAME quantifies all of the results it displays as equally weighted, no single choice option can have a “below normal condition” as it is displayed to the consumer. Things like having to scroll to a result would lessen the value of that provider to an extent, so the number of choices is typically limited to 2-6, less any scrolling and viewing factors as they are present. In summary this feature limits choice in order to increase consumer satisfaction with the choices that are present, which in turn leads to a higher rate of positive result for the provider presented in the ISAME, in turn limiting the degradation of well being for the consumer by the proliferation of too many choices.

The number of choices is limited based on psychological purchasing behavior research. When consumers were given a variety of choices, in a less than more study that looked at the effect the number of choices has on ultimate purchasing decisions, it was found that more choices reduces the ability of consumers to make a positive buying decision, especially after the number of choices exceeds more than six choices. Thus the number of choices is preferably limited to 2-6 in most instances.

The number of choices should exceed one but not exceed six, with the exception of very special cases. Consumers ability to make a positive buying decision when looking at choices also relies on their expectation for the number of choices they would expect to see when choosing. For example, consumers will generally expect to see more than one Honda car dealership in their area, but would not expect to see five or more. It would be expected they would see perhaps two. Exceeding the expected number of choices is not consistent with optimizing the positive purchasing outcome. However, for consumers looking for a puppeteer in their area, it may be plausible that one—perhaps even none—is exactly what one would expect to see. A typical consumer most certainly would not expect to see six puppeteers in any local consumer market. There are several exceptions to exceeding the six choice limit, but it is extremely rare. Restaurants are one of those categories where proliferation of choice is a desirable situation. Consumers expect a large number of choices, and variety in this case actually promotes the decision to “eat out.” These cases are very limited.

The number of choices is also dictated by the viewing situation of the average consumer as it relates to the physical screen space available to display graphical advertisements. Scrolling is a negative characteristic and will diminish the probability that a consumer will take a positive action with regards to purchasing. The larger the physical screen size as an average screen size, combined with the average resolution of the screen display as a default, will dictate how many choices can be displayed, as well as their display size, within the 2-6 choice guideline.

Other graphical limitations that also affect the number of choices as well as their display size would be the average number of toolbars that the average consumer has enabled in their browser applications. This will be an added component to the screen size and resolution to determine how many choices will be allowed between 2-6. As the screen size increases from say 17″ to 19″ the amount of information displayed can be increased, if as well the resolution available on the average increases by one factor that will also increase the viewable amount of “digital real estate” available for display. Combined with the number of additional items such as toolbars that are displayed in the viewers browser will determine the number of choices up to the limit.

Another aspect of the current invention provides for a truly certified search result that is audited and verified on a specified time schedule. Providers agree to adhere to a code of conduct in order to be considered for entry into an ISAME, and only certified providers are granted entry. Upon authorized entry into the ISAME, as determined by the operating organization (typically through an entrance board), the provider(s) must adhere to ongoing procedural inspections. Through these in-person audits and visits to provider business locations, as well as client and process reviews, the operating organization eliminates the pitfalls currently in use regarding social networking peer reviews that clearly do not provide the same level of safety that the ISAME hands on approach does. This level of safety creates an unsurpassed “referral” based model that substantially increases the likeliness that a viewing consumer will select a provider's products and/or services. This referral effect helps to deepen the connection between the local consumer and the local provider, creating an environment where more consumers utilize a fewer number of vendors, creating a coordinated economy, which in turn exponentially increases the sales of the providers in the ISAME. This is another of the ISAME's screening tool mechanisms.

This unique audit and verification process can be best accommodated in a distributed model whereby a physical presence in the local area will perform these duties. Due to the referral nature of the ISAME, as well as its certification process, participating providers are able to charge more for their products and/or services due to the inherent higher quality and convenience. There is also a higher rate of repeat business due to the referral factor. Participating providers are generally able to obtain a higher rate of return on their investment and garner higher margins on the products and/or services they provide.

Another aspect of the engineered portal system is it has a closed design architecture in that the operating organization partners with the participating providers of local products and/or services on an exclusive basis. The operating organization will not partner with any other providers in a given business category once that category is full or closed. That is, the number of providers allowed to be included in each business category is limited to an optimum number, as mentioned above, and once a category has that number of providers on board, the operating organization will not partner with any other providers in that category unless a provider is removed from the category. There are only three ways for the operating organization to remove a participating provider from the ISAME: 1) the provider fails an audit or receives a negative complaint review, thereby indicating a below minimum standard level of service, 2) the provider fails or stops paying its participation fee, or 3) the provider decides to leave or opt out of the ISAME on their own. In any case, a provider being removed from the ISAME provides an opportunity for another provider to enter.

The spots in each category are distributed on a first come first serve basis; there is no bidding for any particular spots within a category. Because the number of listing spots as they are displayed is limited as discussed above, and because the ISAME is a certified and optimized solution, the typical “laws of diminishing returns” as they apply to online viewing and decision making do not apply. The value of all of the spots on any given engineered portal page are closely related and similar. There will be no reason to garner a higher price for the higher spots, and prospective providers will not be motivated to overbid for higher exposure. The ISAME differentiates its providers as a group from non-participating providers. All participating providers will have the same credentials, and all of their spots will be visible without viewing impairment, giving them all the same value.

The current invention uses a pay for inclusion based model and thus has the ability to eliminate inefficiencies of the Pay Per Click (PPC) advertising model offered by many online search engines that provide local content. The operating organization charges a set fee for inclusion, and utilizes these aggregate funds to gain an economy of scale in the promotion of the global ISAME, which in turn drives traffic towards the participating providers. The cost associated with membership in the ISAME is a set fee based on a costing algorithm that identifies the value of the space in the engineered portal to any class of vendor. Providers of high cost, high use, and high margin items will pay a greater exposure fee than lower used and lower profitable items and services, based on this algorithm, as they will reap a larger portion of the locale's revenue dollars.

The costing algorithm can be based on a method of costing that is a true representation of the local economy and the vendor's value within the locale. The ISAME utilizes a pay as you would reap costing method that includes many factors of cost. This logical costing represents the fairest way to assess a charge on local vendors with regards to the value they will receive, as well as the value of the resources that would be applied as a percentage of the whole towards that “classification” of vendor. The ultimate cost is derived from a set of increase and decrease factors to a basis point for charge. These factors include, are not limited to, the following:
A vendor that produces an average cheaper sale would have a lower factorization on this characteristic than one that would have a very high average cost of a sale. An auto dealer would have a higher factor than a variety store having an average sale of under ten dollars.
The average margin derived from the average sale could be another factor. The selling of services produces higher average margins than the selling of a product. The factor for this characteristic would be higher for most service oriented vendors.
The percentage of the local economy a vendor's offering equates to as a total marketplace. If the number of autos sold equated to a 10% share of the gross product of the area, that factorization would be higher than an offering that only garnered 5%. Auto dealers may utilize for example a 1.1 factor versus a 0.9 factor for the vendor whose main product only shares a 5% of the total gross product for the area.
Population size per area. Areas that have much smaller populations would have a lower than one factor, those with high populations would have a higher than one factor. If the opportunity is higher, than the value is considered higher. Factors for population are based on the base population of the main area center, all others would be an under 1.0 factor as the areas move lower from the base population.
Population density is another factor. Obviously businesses that would benefit from reduced travel distance would get more value from a consumer opportunity than businesses that would be more susceptible to decline in business based on longer commuting distances. Those vendors in highly dense population areas would have a higher than one factor, those in less dense areas lower than one. The more likely the population density benefits a vendor, the higher away from a factor of one that factor becomes.
Chance of repeat business versus non-repeat business. If there is a high likelihood of repeat opportunity, the factor would be higher than an opportunity with limited repeat success. Vendors with no chance of repeat business would be the base, for example, those with a high rate may have a factor of 1.2, 1.3, and so on depending on the extent to which repeat business is likely, and within what time frame.
Competition factor is determined based on the level of competition. If there are many vendors competing in the area, the factor will be higher than if there is little or no competition. The value to entrance would be more valuable and would garner a higher than 1 factorization.
Traffic flows through areas also will affect the cost. Vendors whose offerings are positively impacted by an increase of commuter traffic will have a higher than one factor as opposed to those businesses that are not impacted as much.

This fee model provides for the security and protection of the providers' allocated marketing budgets. As the ISAME is an exclusive pay for inclusion based model, there is no opportunity for fraud based PPC issues. The ISAME is not riddled with the large growing number of online search related issues such as click fraud, and social networking drawbacks. Although the ISAME predominantly stops PPC campaign problems, it is not limited to the resolution of these problems only, the ISAME can solve this as well as other online search engine and directory pitfalls, herein known as “fraudulent advertising internet costs” (FAIC), such as false reviews, paid online reviews, as well as others. By virtue of its exclusivity, the ISAME protects providers' investment in their marketing campaign. Other solutions offer positions based on the ability of one to pay the most for a represented position. In the present invention, the operating organization enters into a partnership under a specific set of terms, and cannot discontinue that arrangement until the provider stops paying or no longer meets the quality levels set forth and agreed upon during registration into the ISAME. As with any marketing campaign the repetitive nature and longevity of the campaign directly relates to the level of success any provider sees. No authorized provider can lose their investment by being dropped from the ISAME because of another provider's willingness to take their spot. Their investment is protected. The ISAME also eliminates the ever-growing problem of click fraud, and the unpredictable expenditure related to pay per action scenarios.

Another feature of the current invention is the utilization of an innovative approach to driving targeted traffic to a physical or digital (in the form of an address or a web URL locator address) location. The ISAME provides for an intercepted mount point to the Internet and World Wide Web via a Targeted Audience Initiator (TAI) arrangement, which is described in co-pending U.S. Patent Application No. [32188-1US01], which is incorporated herein by reference. This capturing of the consumer mount point is useful in obtaining viewership at costs that maximize ROI for marketers. The TAI encourages consumers to log directly into the engineered portal via its push technology, and circumvents previously bookmarked mount points, “mount points” meaning the location an Internet browser goes to upon immediately being started. By capturing this initial mount point via a co-branded TAI arrangement, the TAI beneficiary, i.e., the engineered portal, garners the traffic that would normally visit a search engine or directory as its mount point, providing the participating providers an increased viewership for their local products and/or services. This mount point intercept could be as simple as an automatic bookmark, an online log in to a specified referred web address URL. This intercept could also be in the form of a desktop applet, or widget that would allow the ability to circumvent the opening of a browser altogether. This intercept is not limited to those mentioned above as there are other technologies current and future that would provide for this intercept.

The ISAME also utilizes factors of online consumer searching habits, and how they relate to overall consumer satisfaction during the process of purchasing or specifying products and/or services online. The ISAME is tuned to obtain the maximum positive benefit for its registered clients, creating a usable, and desirable mount point for local products and/or services that increases the likelihood of a positive outcome for its clients.

Another feature of the ISAME is the deliberate use of “complete information” design. It has been studied and found that the lack of complete information can negatively impact current buying decisions, as well as all subsequent decisions. (See, Kivetz, Ran and Simonson, Itamar, “The Effects of Incomplete Information on Consumer Choice,” Journal of Marketing Research, 37 (4), November 2000.) By including information on common attributes between participating providers of like products and/or services, as well as information regarding the products and/or services themselves, the ISAME increases the likeliness of a positive action for a participating provider than would otherwise be possible. Common attributes for consumer products that could be provided include: quality, price, reliability, location, ease of use, as well as many others. By deliberately producing this information within the shell of the ISAME, consumers can be influenced into making favorable buying decisions. The ISAME strategically and purposely includes all of the relevant “common attribute” information to enable consumers to make easy decisions based on full disclosure of the attributes. The ISAME includes these common attributes as well as any unique ones in an attempt to cover 100% of the basis of consumer preferences and values. The ISAME builds predetermined “choice sets” to maximize the closure rate of an action by the consumer on behalf the participating providers. By combining certified and audited providers with any related information needed to make an educated decision, the ISAME exponentially increases the likelihood of success as it pertains to a buying or specification decision.

Another feature of the current invention is that the operating organization controls all aspects of information presented in the ISAME. Participating providers in the ISAME do not have the ability to present un-monitored or un-reviewed information within the ISAME. All presented information is reviewed by the operating organization (such as by a content board and/or a marketing board within the operating organization). All information and graphic representations with the exception of branding items of providers within the ISAME are preferably designed by the operating organization, utilizing the operating organization's professional marketing skills. All of the content down to the individual provider presences are controlled and optimized by the ISAME portal design and content managers. This can be done because it is local in nature. Traditionally, search engines and directories that utilize anything other than links will allow the individual or organization the flexibility to create their own advertisement, completely neutralizing the upside potential of the exposure. Unless the provider itself is a marketing and advertising firm, there will be no professional design and implementation undertaken.

This feature guaranties the quality, image and consistency of the information and data presented within the ISAME. Consistency is an important factor when consumers are reviewing options for providers of products and/or services. This feature also minimizes the consumer confusion pertaining to conflicting impressions that online directories and search engines provide by leading consumers from their presence to that of their advertiser. In conventional directories and search engines, there is no control over the image that a consumer sees once they are taken off of the entry site. That confusion can delay and deter a consumer buying decision. As the ISAME is a fully managed presence, all off-portal exposure site links must be approved by the operating organization. If the off-portal site image is not suitably matched to the ISAME's presented image, a secondary page can be added within the ISAME as a link page to promote the provider's products or services. This consistent impression will increase the likelihood of success for the provider.

Another feature is the distributed distribution model based on physical presence in particular locales. This presence allows for the greatest penetration and coverage of any geographic area, benefiting the consumer as well as the participating providers. The ISAME is tuned for distributed replication, i.e. franchising, to provide a truly local search engine replacement. There is no current method or entity that combines a local physical presence in a local area, with a certified search result, and a certified result that is not reliant upon social networking schema. This franchise model also allows for economies of scale with regards to content development. As the volume of content rises within the ISAME and its online presence, the ranking in the search engines increases, which will continually drive further traffic to the ISAME as consumers search under generic local search terms. This differentiates the ISAME from other current methods because as the volume of content grows it will do so with local flavor, as much of that content will be driven by franchisees or affiliates in their respective local areas. It will not be driven nationally by a centralized organization. Differentiation of content is key to Internet ranking as duplicate content does not help your online ranking, but related content helps. As the group of members grows so does the library of related content, which will increase the ISAME's ranking, thus achieving a marketing economy of scale only possible by implementing extremely large volumes of related data. The local presence also allows for the adoption of local customs, as well as the presentation of area specific information. The custom design of the ISAME will allow local consumers the ability to obtain information that is of the most importance to them in their local environment.

Another aspect of the current invention includes a specific design to accommodate for the negative impact of competitive advertising on the decision making process of consumers towards local providers of products and/or services. When local consumers are exposed to advertising for several competing products and/or services within a short time frame, they become numb to the aggregate pool of all promotion, negating any positive effects for the advertising itself. The ISAME removes this impact by limiting choice, and presenting the proper information needed to make an educated choice when choosing a local product or service. The ISAME by its unique push technology will intercept consumers during their time of determination, and will bypass all current methods of promotion, removing the issue of advertising interference. The ISAME will intercept the consumers' mount points to the Internet and become the default standard to come to when specifying a local product or service. Participating providers will be the only alternatives available during the precise buying cycle time of any local consumer. Advertising recall is diminishing yearly, and the ISAME removes the need for recall of providers of local products and/or services. As well the ISAME does not rely on the recall of an “ad” to drive traffic towards its providers, as does other current technology.

This feature removes the effects of competitive advertising interference, which paralyzes consumers, and stops them from making positive decisions pertaining to a buying cycle. The ISAME is designed to remove interference by allowing a set number of choices, and limiting any cross-promotional spots within a category to one, complimentary, but not competing, product or service. This deliberate choice by the ISAME allows for no advertising interference. The operating organization must approve all cross-promoted spots prior to display; providers cannot merely purchase the spot without approval. Moreover, the ISAME does not suffer from competitive advertising interference globally within the portal, as most consumers will utilize the engineered portal at the time they are specifying or purchasing a product or service.

Another feature is that the ISAME provides for the creation of a “coordinated economy” via the combination process of the included system. Local consumers benefit from the ISAME and its process by utilizing its unique selection process based on certified results, quality control aspects, and ability to drive a large targeted group to a small number of vendors. As the ISAME attracts consumers because of its consumer safety attributes, the participating providers increase their business, furthering their depth and breadth of market share, allowing them to attract an even larger percentage of the local market, which in turn allows these highly sought after providers the ability to offer more products and/or services at more attractive terms to the community, further enhancing the local market itself. In essence, it is of greater economic value for a smaller number of better-qualified firms to attract a larger portion of the locale's economic benefit. This highly concentrated market offers many benefits to the social structure of the locale, which in turn rewards the ISAME by greater viewership, broadening the circular economic influence of the ISAME. Local coordinated economies have shown that they can increase social welfare, which in turn increases consumer satisfaction, and reduces buyer's remorse. This process increases the likelihood of success of the ISAME participants for current and future buying decisions.

Another aspect of the ISAME allows for small to mid sized businesses to gain online search exposure at a reasonable cost, beyond the exposure they would be able to obtain on their own. Most conventional search engine algorithms are comprised of many factors, several being longevity of domain, quality and relevance of content, and quality and complement of related content, as well as inbound and outbound links. As the perceived importance of online search becomes greater, more and more larger national and global providers are garnering much of the organic and paid results on search engine pages. They do this by utilizing a large web development budget to create volumes of content and related content, and they pay for the display of their advertisements in pay per click or pay per lead models. These economies of scale cannot be matched by local small to mid sized businesses, as their budgets for promotion are small to none. By utilizing the large ISAME network of information, content, links, and longevity, these small to mid size business can get relevance for search engine results through the ISAME. Another process within the ISAME is sub-domain wrapper technology whereby a local provider's presence, in the form of a sub domain within the ISAME domain, within the engineered portal is wrapped to provide maximum relevance and exposure. As the aggregate ISAME increases in size via its distributed franchise model, the ranking of the ISAME portal itself grows exponentially. Individuals achieve an online presence they could not do on their own, or in combination with outsourced service providers. This ranking would otherwise be outside of the realm of possibilities for small entrepreneurs as their web presence would not be able to compete with larger national entities. The conglomeration of information in its entirety provides the relevance factors needed to gain top ranking, hence through the ISAME indexing the participating providers will get exposure.

Another aspect of the ISAME is the process by which the engine eliminates the “cost of search,” which can be measured in real time, or emotional duress. By limiting the number of choices to an optimal number, consumers no longer have to go the Internet and decipher the mountains of data that are presented in any one search pertaining to an item that can be found locally. With this reduction in emotional cost, combined with the reduction in hard time cost in doing a desired search, consumers become more satisfied with their choices and are more likely to come back to that source of information in the future, further building a coordinated economy of scale for the providers represented in the ISAME.

A further feature is the design implementation with regards for population and geographic demographics. Due to its truly local presence, the ISAME is designed to be a representation of the natural local economic flow of goods and services within an area. The ISAME locale is determined by this natural area demographic; this demographic is calculated by, but not limited to, the following statistics: population, population density, geographic dispersion, accessible transportation avenues, and geographic barriers. Seemingly cohesive areas, such as a city area, may not be the logical and actual economic “circle.”

The ISAME calculates this “circle” and breaks the area into multiple ISAME entities to meet the criteria.

The ISAME also provides for an integrated digital and physical promotion of the participating providers. The operating organization can utilize customized local monthly magazines specialized for local characteristics, as well as a group of traditional promotional items, to increase traffic to the ISAME online presence.

Another aspect of the current invention negates the negative impact of national, global, as well as search engine provided paid for results found on other solutions presences. As the ISAME is represented by local presence in the defined area, the operating organization can actively seek providers for representation in the ISAME. They can use unique incentive methods such as economic incentive for referrals usable at member locations only, as well as TAI services. These methods provide for the quickest solution to maximum enrollment and profitability. Other solutions that wait for providers to contact them for enrollment, as they are national organizations, or have no physical local presence, must subsidize this waiting period by offering national organizations, and search engine representations within their presence, the ability to be represented for a charge. This takes away from any local providers that are represented. The ISAME does not allow a crossover between national and localized information as it decreases conversion rates for businesses and increases search time and confusion for consumers.

According to another aspect of the invention, optimization of the chance of a desired event to occur is greatly heightened when compared to all other inventions as the ISAME does not rely on the use of “cookie” technology to display regional local results. Other implementations are limited to their national scope, utilizing cookie technology to identify characteristics of online users via their browsers. This information can include, but is not limited to, personal statistics, geographic location, and browsing habits. As the Internet evolves and users become savvy, they understand the implications of allowing cookies to be present on their computers, and of being utilized by the sites they visit. Cookies greatly threaten security of the user, as well as violate privacy issues. This has not been a large issue until recently, as most users had no idea of the technology, it's uses, and its downside. Cookie implementation commonly comes turned on in new system browsers, and currently more and more people, especially in business environments, are turning off the features of cookie implementation, degrading the accuracy of other implementations results, those sites can no longer dictate information display based on cookie data. The current invention does not rely on cookie technology to display needed information and therefore is more accurate, and will be even more accurate per user as time goes on. This enhances the users experience, pulling them to utilize the services of the ISAME more deeply, providing a more enhanced and optimized chance of positive action on the behalf of the user towards a provider in the ISAME engineered portal.

While specific embodiments of the present invention have been described, it should be noted that various modifications thereto can be made without departing from the spirit and scope of the invention as defined in the appended claims.

What is claimed is:

1. A method of using a computer-based system to market local products and/or services, said method comprising:
establishing a database of providers of local products and/or services, wherein said providers are classified into one or more business categories and each provider is certified;
receiving a request from a user for information about providers of local products and/or services in a specified business category; and
causing a list of providers classified in said specified business category to be displayed to said user, wherein said list has a limited number of providers.

2. The method of claim 1 wherein said limited number of providers is optimized to avoid an excessive number of choices.

3. The method of claim 1 wherein said limited number of providers is calculated based on user viewing factors, said user viewing factors selected from the group consisting of: users' desire to scroll, how far users will scroll, screen size dimension, pixel resolution, screen lines, and browser tool bar implementation.

4. The method of claim 1 wherein each provider is certified by a certification process that includes a background check and/or interviewing references provided by each provider.

5. The method of claim 4 wherein said certification process further includes periodic audits of said providers.

6. The method of claim 1 wherein each provider is required to agree to adhere to a code of conduct.

7. The method of claim 1 wherein, once certified, a provider can be removed from said database only by failing to meet a standard level of service, failing to pay a required fee, or deciding to be removed from the database.

8. The method of claim 1 further comprising charging each provider a set fee to be included in said database.

9. The method of claim 8 wherein said set fee is based on a costing algorithm that identifies the value of being included in said database.

10. The method of claim 1 further comprising causing information about said providers and/or their products and/or services to be displayed to said user together with said a list of providers.

11. The method of claim 10 wherein said information about said providers and/or their products and/or services is selected from the group consisting of: quality, price, reliability, location, and ease of use.

12. The method of claim 10 wherein all information displayed to said user is approved prior to being displayed.

13. The method of claim 1 further comprising providing for an intercepted Internet mount point via a Targeted Audience Initiator arrangement.
